(19) United States
(12) Patent Application Publication
(10) Pub. No.: US 2026/0127690 A1
(43) Pub. Date: May 7, 2026

(54) TRUST MANAGEMENT SYSTEM AND METHOD

(71) Applicant: JOiNVEST Co., Ltd., Taipei (TW)

(72) Inventor: Wei Lin, Taipei (TW)

(21) Appl. No.: 18/937,214

(22) Filed: Nov. 5, 2024

(51) Int. Cl. H04L 9/32

(52) U.S. Cl. CPC G06Q 50/18; H04L 9/321

(57) ABSTRACT

Provided are a trust management system and method, including a settlor module, a trustee module, a beneficiary module and a trust digital management module and effective in introducing automated and intelligent processing processes. The trust digital management module includes a trust-related question bank. The settlor control interface presents a plurality of questions of the trust-related question bank. The settlor module provides the trust digital management module with answers given by the client to the questions to allow the trust digital management module to create a digital trust agreement according to the answers. The settlor tracking module sends a message notification to the client according to application progress to reduce the need for human interventions, enhance trust application efficiency, and enable information to be real-time.

### BACKGROUND OF THE INVENTION

### Field of the Invention

The present disclosure relates to trust management systems and methods, and more particularly to a trust management system and method for processing digital services.

### Description of the Prior Art

In the field of trust management, human-initiated integration processes play an important role in professional consultation, financial business and legal compliance. Furthermore, trust management relies on human-initiated processing processes, such as filing trust applications by clients, reviewing application contents, drafting and revising agreements, and processing application documents. However, existing trust management systems rarely come with a real-time application and examination mechanism. As a result, after receiving trust applications from clients, existing trust management systems have to spend much time waiting for examination and processing and thus fail to meet the clients'needs and expectations for real-time trust application in the rapid financial realm. Trust management relies heavily on human-initiated processing processes, such as examining application contents and processing application documents, and thus is inefficient as well as liable to errors and inaccurate information transmission.

Furthermore, existing systems cannot provide any effective tracking and notification mechanism and thus cannot provide application progress, examination results of important documents or other related information to clients in real time, precluding information from being real-time and clients from being aware of the state and result of trust processing in real time. In particular, steps and operations of trust management are discrete and lack integration to the detriment of information flow and information sharing, which in turn is a major reason affecting efficiency and precision of the trust management.

The disclosure is aimed at providing a novel trust management system and method effective in integrating applications, tracking trust application progress, and notifying a client of related information timely. Therefore, the disclosure has high industrial applicability and practicability.

### SUMMARY OF THE INVENTION

In view of the aforesaid drawbacks of the prior art, it is an objective of the disclosure to provide a trust management system and method effective in introducing automated and intelligent processing processes, reducing the need for human interventions, and enhancing efficiency and Information timeliness.

The disclosure provides a trust management system comprising: a settlor module comprising a settlor control interface and a settlor tracking module, the settlor control interface receiving a trust application filed by a client; and a trust digital management module comprising a trust-related question bank, wherein the settlor control interface presents a plurality of questions of the trust-related question bank, and the settlor module provides answers to the questions by the client to the trust digital management module so as to allow the trust digital management module to create a digital trust agreement according to the answers, wherein the settlor control interface presents the digital trust agreement to allow the settlor module to perform electronic signature function and then notify the trust digital management module of conducting trust financial business online, wherein the settlor tracking module issues a message notification to the client according to application progress.

The disclosure further provides a trust management system, wherein the message notification is about a result of the trust financial business or about completion of creation of a trust. The trust financial business comprises one of a crediting, an undoing crediting, a debiting, a remittance and an assets transfer. The settlor module further comprises a settlor integration module connected to the trust digital management module and adapted to provide electronic signature function, and the settlor control interface presents a plurality of questions and the digital trust agreement.

The disclosure further provides a trust management system further comprising: a trustee module comprising a trustee control interface and a trustee tracking module, the trustee control interface presenting the digital trust agreement to a trustee, the trustee module executing the electronic signature function and then confirming that trust assets have been remitted to a trust account of the trustee to issue a trust creation notification to a trust-related party; a beneficiary module comprising a beneficiary control interface and a beneficiary tracking module, the beneficiary control interface presenting the digital trust agreement to a beneficiary, the beneficiary providing one or more supporting documents as needed through the beneficiary control interface or authorizing one or more supporting documents retrieved in order for the trustee to verify whether the trust conditions are met, and the beneficiary tracking module connecting to the trust digital management module to perform regular management tracking and notify the beneficiary.

The disclosure further provides a trust management system further comprising: a management module and an execution module, wherein the management module regularly manages the trust conditions and sends a result message notification to the trust-related party. When the trust conditions are met, the execution module executes the digital trust agreement and transfers trust assets to the beneficiary; a trust creation module, an analysis module, a transaction module and a digital information module, with the trust creation module linked to the analysis module and the digital information module to create the digital trust agreement, with the analysis module analyzing client background and needs with an algorithm, selecting the plurality of questions from the trust-related question bank of the digital information module according to the answers, and sending the plurality of questions to the trust creation module, the transaction module is series-connected to a bank app interface to conduct the trust financial business.

The disclosure provides a trust management method, comprising the steps of: presenting at least one trust question and a digital trust agreement to a client through a settlor control interface to obtain an electronic signature affixed by the client to the digital trust agreement; executing online crediting of a designated account of the digital trust agreement; confirming successful execution of the trust financial business, and then presenting the digital trust agreement to a trustee through a trustee control interface to obtain an electronic signature affixed by the trustee to the digital trust agreement; debiting the designated account and remitting money to an account of the trustee through being series-connected to a bank app interface; notifying, upon confirmation of successful debiting, the client of creation of the digital trust agreement; and executing regular management of the digital trust agreement; inquiring, through a trust digital management module and a beneficiary tracking module, regularly about whether trust conditions are met; notifying by the trust digital management module as needed, when the execution conditions are met, a beneficiary of its obligation to provide supporting documents or authorize supporting documents retrieved. After the trustee has perused the supporting documents on the trustee control interface and performed online verification of the supporting documents, trust assets are transferred to the beneficiary under the digital trust agreement. The trust management system further executes the step of notifying, by a trust digital management module, regularly or according to the trust agreement, a beneficiary of its obligation to provide one or more supporting documents or authorize one or more retrieved supporting documents about trust conditions having been met.

The disclosure further provides a trust management method comprising the steps of: issuing by the settlor control interface a failure information notification to the settlor if crediting and debiting fail; and issuing by the settlor control interface a failure information notification to the settlor if the trustee refuses to or fails to provide before a trust-specified deadline the trustee electronic signature affixed to the digital trust agreement; when the digital trust agreement stipulates that trust execution requires the settlor's giving consent to or authorizing the trust execution, the settlor has to provide consent to or authorize the trust execution through the settlor control interface, a trust digital management module transfers trust assets only after the trustee has received the consent or authorization from the settlor.

The trust management system and method of the disclosure enable the trust-related party to file a trust application conveniently and quickly and are effective in integrating intricate financial business procedures, such as crediting and authorization, introducing automated and intelligent processing processes, reducing mistakes otherwise arising from human interventions, enhancing trust application efficiency and Information timeliness.

### BRIEF DESCRIPTION OF THE DRAWINGS

FIG. 1 is a schematic view of a trust management system of the disclosure.

FIG. 2 is a block diagram of the trust management system of the disclosure.

FIG. 3 is a block diagram of a trust digital management module of the trust management system of the disclosure.

FIG. 4 is a schematic view of a process flow of applying for a trust with the trust digital management module of the trust management system of the disclosure.

FIG. 5 is a schematic view of a process flow of the trust digital management module of the trust management system of the disclosure.

### DETAILED DESCRIPTION OF THE EMBODIMENTS

Objectives, features, and advantages of the disclosure are herein illustrated with specific embodiments, depicted with accompanying drawings, and described in detail below. It is noteworthy that the specific embodiments are illustrative of the disclosure but shall not be interpreted as restrictive of the scope of the claims of the disclosure.

A more complete description of the disclosure is made with reference to the drawings, and specific embodiments are revealed by illustration. However, the subject matter claimed by the disclosure can be implemented in various ways; hence, the subject matter falling within the scope of or claimed by the disclosure is not restricted to any specific embodiments of the disclosure. The specific embodiments of the disclosure serve illustrative purposes only. Likewise, the disclosure is aimed at defining reasonably broad scope of the subject matter falling within the scope of or claimed by the disclosure. Furthermore, for example, the subject matter claimed by the disclosure can be implemented by a method, device or system. Therefore, the specific embodiments can be provided, for example, in the form of hardware, software, firmware or any combinations (not existing software) thereof.

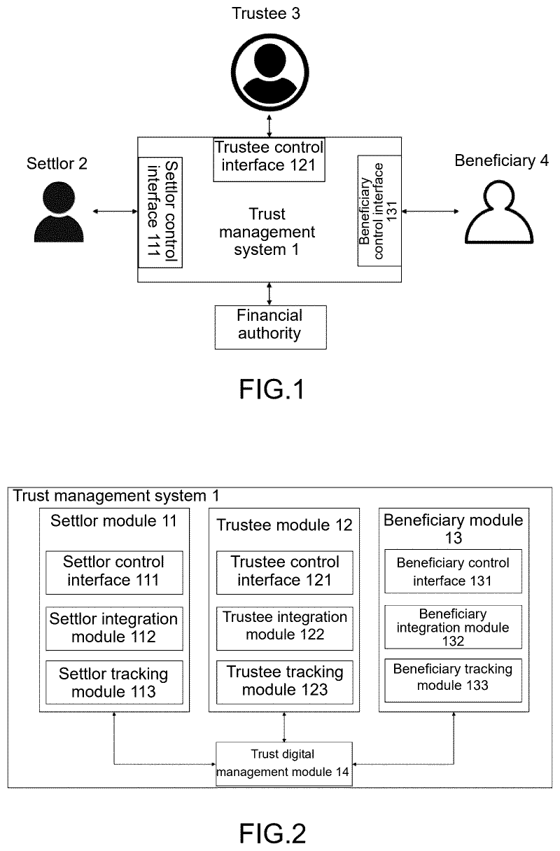

Referring to FIG. 1, there is shown a schematic view of a trust management system 1 according to a specific embodiment of the disclosure. The trust management system 1 comprises a settlor control interface 111, trustee control interface 121 and beneficiary control interface 131. The interfaces 111, 121, 131 are accessible to a settlor 2, a trustee 3 and a beneficiary 4 respectively to render trust application and authorization convenient and quick. The trust management system 1 conducts financial business, such as crediting, debiting, remittance, and assets transfer, online with a designated trust account and financial authority to preclude mistakes otherwise arising from human interventions, enhance trust application efficiency, and enable information to be real-time.

Referring to FIG. 2, there is shown a block diagram of the trust management system 1 according to a preferred embodiment of the disclosure. The trust management system 1 of the disclosure comprises a settlor module 11, trustee module 12, beneficiary module 13 and trust digital management module 14. The settlor module 11, trustee module 12 and beneficiary module 13 process the operation and notification of the settlor 2, the trustee 3 and the beneficiary 4 respectively. The trust digital management module 14 provides required information at the request of the modules 11, 12, 13 and conducts financial business, such as crediting, debiting, remittance, and assets transfer, online with a designated trust account and financial authority.

The settlor module 11 comprises a settlor control interface 111, settlor integration module 112 and settlor tracking module 113. The settlor 2 is linked to the trust management system 1 of the disclosure through a mobile device or various apparatuses that can be connected to the Internet. The settlor control interface 111 provides functions enabling the settlor 2 to register, log in and log out, edit personal data, commission trust business, inquire about trust business progress, and provide consent to or authorize the trustee 3 to carry out assets transfer. The settlor control interface 111 of the settlor module 11 of the trust management system 1 is accessible to the settlor 2.

The settlor control interface 111 receives an input data related to trust application services from the settlor 2, and provides application data to the trust digital management module 14 to obtain questions filtered from a system question bank. The questions are displayed to the settlor 2 through the settlor control interface 111, so as to receive answers provided by the settlor 2 to the questions and provide the answers to the trust digital management module 14. The trust digital management module 14 creates a digital trust agreement according to the answers, dispensing with intricate human-based agreement drafting and reviewing. The settlor integration module 112 receives the trust agreement from the trust digital management module 14. Then, the trust agreement is displayed to the settlor 2 for reviewing and confirming through the settlor control interface 111. Next, the settlor integration module 112 instructs the settlor 2 to perform electronic signature to sign the trust agreement. After the settlor module 11 has received the trust agreement signed by the settlor 2, a transaction module 143 of the trust digital management module 14 performs crediting on a bank account of the settlor 2 according to the trust agreement.

The crediting requires the transaction module 143 of the trust digital management module 14 to credit an amount equivalent to the value of the trust assets to a trust account designated or a bank designated by the settlor 2 after the settlor module 11 has received a trust application from the settlor 2. Where the settlor 2 credits an amount equivalent to the value of the trust assets to a bank designated by the settlor 2, the amount remains in the account of the settlor 2 until the trustee 3 takes on the trust agreement, and the debiting is completed only upon the conclusion of the trust agreement, achieving risk control. In an embodiment of the disclosure, the transaction module 143 of the trust digital management module 14 determines in real time whether the crediting of the amount succeeds. If the crediting fails (the trustee's account has not received the amount), for example, the bank account of the settlor 2 does not have a sufficient amount for performing crediting, and upon an affirmative determination the settlor tracking module 113 notifies the settlor 2 of a trust creation failure and requests the settlor 2 to replenish the bank account until the balance thereof is equal to the agreed credit amount, the transaction module 143 regularly confirms whether the crediting succeeds before a deadline specified in the trust agreement, confirming that the trust agreement has not yet come into force when the bank account has not yet been replenished to make the balance thereof equal to the agreed credit amount by the deadline. Upon confirmation that the crediting has succeeded, a management module 145 of the trust digital management module 14 carries out a Know Your Customer (KYC) check. If the KYC check passes, the trust digital management module 14 will send the trust agreement to the trustee module 12.

Referring to FIG. 1 and FIG. 2, the trustee module 12 comprises a trustee control interface 121, trustee integration module 122 and trustee tracking module 123. Upon completion of the crediting process performed by the trust management system 1 of the disclosure, the settlor tracking module 113 of the settlor module 11 enters a waiting stage, and the trustee module 12 of the trust management system 1 notifies the trustee 3. The trustee control interface 121 presents the notification to the trustee 3 and instructs the trustee 3 to or not to take on the trust agreement. The trustee control interface 121 of the trustee module 12 provides functions enabling the trustee 3 to register, log in and log out, edit personal data, be appointed to take on trust business, inquire about trust business progress, and verify trust conditions. Upon confirmation that the trustee 3 has logged in successfully, the trustee control interface 121 presents the signed trust agreement to the trustee 3 for perusal and review.

If the trustee control interface 121 of the trustee module 12 receives from the trustee 3 a reply of refusal to take on the trust agreement, the trustee tracking module 123 of the trustee module 12 will report the refusal reply to the settlor module 11, causing the settlor tracking module 113 of the settlor module 11 to issue a trust creation failure notification to the settlor 2, and the transaction module 143 of the trust digital management module 14 to undo crediting. If the trustee control interface 121 of the trustee module 12 receives from the trustee 3 a reply of acceptance to take on the trust agreement, the trustee integration module 122 of the trustee module 12 will instruct the trustee 3 to perform electronic signature to sign the trust agreement. After the trustee integration module 122 has received the trust agreement signed by the trustee 3, the trust management system 1 remits an amount equivalent to the value of the credited trust assets of the settlor 2 to a trust account of the trustee 3. If the debiting fails, the trustee tracking module 123 will notify the trustee 3 of the failure to create the trust, send a debiting failure notification to the trust management system 1, and execute the remittance anew. If the debiting succeeds, the trustee tracking module 123 will notify the trustee 3 of the completion of creation of the trust and instruct the settlor tracking module 113 to send a trust creation completion notification to the settlor 2.

Upon confirmation of the completion of creation of the trust, the trust digital management module 14 carries out regular trust management and executes trust contents. The regular trust management requires the trust digital management module 14 of the trust management system 1 to inquire an app and a database platform about whether trust conditions, i.e., “the beneficiary 4 is aged 20 or over, and an assets transfer is started,” are met. If the trust conditions are satisfied, the trust contents will be executed. The trust contents include a plurality of trust conditions and/or a plurality of assets transfer items.

Referring to FIG. 1 and FIG. 2, the trust digital management module 14 of the trust management system 1 inquires the app and database platform about whether the trust conditions are met. If the trust conditions are met and the beneficiary 4 has to provide one or more supporting documents, the beneficiary tracking module 133 of the beneficiary module 13 in the trust management system 1 will request, through the beneficiary control interface 131, that one or more supporting documents be provided by the beneficiary 4, or the supporting document(s) retrieved be authorized by the beneficiary 4, and the supporting document(s) retrieved be sent to the trustee 3 through the trustee control interface 121 so as to be verified by the trustee 3. The beneficiary control interface 131 provides functions enabling the beneficiary 4 to register, log in and log out, edit personal data, provide beneficiary-related data, provide trust condition supporting documents, provide retrieval authorization supporting documents, and inquire about trust business progress.

Upon confirmation that the beneficiary 4 has logged in successfully, the beneficiary control interface 131 requests, as needed, that the supporting document(s) be provided by the beneficiary 4, or the supporting documents retrieved be authorized by the beneficiary 4, and the supporting document(s) retrieved be sent to the trustee 3 through the trustee control interface 121 so as to be verified by the trustee 3 to determine whether the trust conditions are met. If the supporting document(s) are wrong, the beneficiary 4 will be requested to provide one or more supporting documents or authorize one or more supporting documents retrieved. If the supporting document(s) are not wrong, it will mean that the conditions for executing the trust agreement are met, requiring the beneficiary tracking module 133 to notify the settlor 2 through the settlor tracking module 113 and the trustee 3 through the trustee tracking module 123 of the upcoming execution of the trust, and requiring the trust assets be transferred to the beneficiary 4 through the trust digital management module 14. If the trust agreement stipulates the execution of the trust, the settlor 2 will provide consent or authorization through the settlor control interface 111. It is only when the trustee 3 becomes aware that the settlor 2 has provided consent or authorization that the trust assets can be transferred to the beneficiary 4 through the trust digital management module 14.

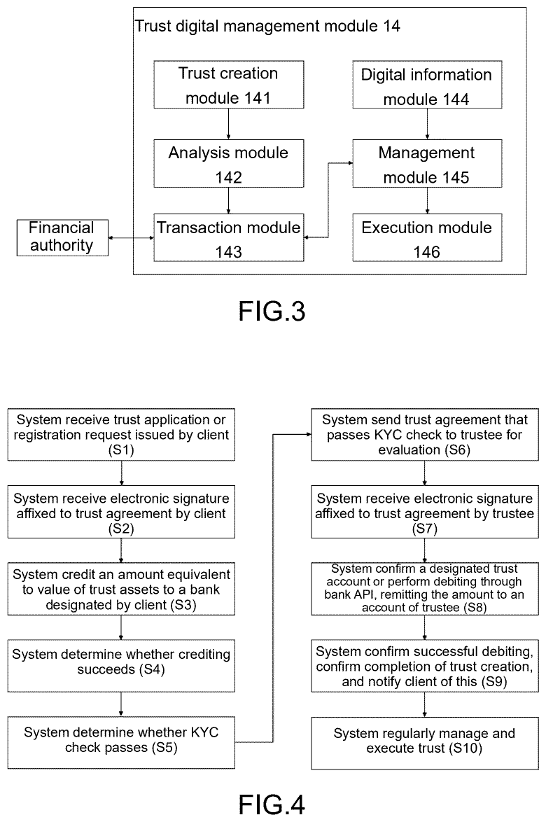

Referring to FIG. 3, there is shown a block diagram of the trust digital management module 14 of the trust management system 1 of the disclosure. Referring to FIG. 4, there is shown a schematic view of a process flow of applying for a trust with the trust digital management module 14 of the trust management system 1 of the disclosure. The trust digital management module 14 comprises a trust creation module 141, analysis module 142, transaction module 143, digital trust information module 144, management module 145 and execution module 146. In an embodiment of the disclosure, when the settlor control interface 111 of the trust management system 1 receives a trust application or registration request issued by the settlor 2 (S1), the trust creation module 141 of the trust digital management module 14 creates forms required for the trust agreement, whereas both the analysis module 142 and the digital trust information module 144 of the trust digital management module 14 analyze, add new data to, remove data from, and update a digital trust questions database according to background information inputted by the settlor 2 to select appropriate questions. Then, the settlor control interface 111 presents the selected questions to the settlor 2 to serve as the basis of reference for use in creating a trust agreement.

In a specific embodiment, settlor A provides data through a settlor interface as follows: male, aged 42, working in the financial sector; the purpose of creating the trust is to plan and manage an educational fund for my children; database selection sample questions for reference in creating a trust agreement are as follows: Are you planning to send your children abroad for studying? Are you planning to provide your children's living expense funding regularly? Are you planning to allow the beneficiary of trust assets to be other beneficiaries and allow the beneficiary of fruits of trust assets to be the settlor? Are you planning to separate the right of claiming the distribution of the remainder of statutory matrimonial property? Can a remarried child become an additional beneficiary? In another specific embodiment, settlor B provides a trust interface with data as follows: aged 35, professional military officer; the purpose of creating the trust is to plan and manage an educational fund for my children; database selection sample questions for reference in creating a trust agreement are as follows: Do you want to select remitting settlor money to the trust account regularly? Are you currently the insured under a life insurance policy? If yes, do you want to add the insurance payout to the trustee account for the educational fund? If a settlor passes away, can a surviving spouse take care of the trust assets? Will the trust allow the settlor to withdraw the trust assets? What will be the conditions for withdrawal?

After receiving answers to the questions from the settlor 2, the settlor module 11 provides the answers to the trust digital management module 14. Then, the trust creation module 141 of the trust digital management module 14 creates a digital trust agreement according to the answers and sends, via the settlor module 11, the digital trust agreement to the settlor 2 in order for the settlor 2 to perform electronic signature function on the digital trust agreement. The management module 145 of the trust digital management module 14 accesses the signed trust agreement (S2).

Referring to FIG. 3 and FIG. 4, after the trust digital management module 14 has received the signed trust agreement, the transaction module 143 confirms a designated trust account or credits an amount equivalent to the value of the trust assets to a designated bank accredited by a financial authority according to a debiting method designated in the database by the settlor 2 (S3). The transaction module 143 immediately determines whether the crediting succeeds (for example, whether the amount has been received) (S4). If the crediting fails (for example, the amount has not yet been received), for example, the bank account of the settlor 2 does not have sufficient money to carry out crediting, the transaction module 143 sends a crediting failure notification (for example, about the amount having not yet been received) to the settlor 2 through the settlor tracking module 113 and requests the settlor 2 to replenish the bank account until the balance thereof is equal to the agreed credit amount. If the settlor 2 fails to replenish the bank account until the balance thereof is equal to the agreed credit amount before a deadline specified in the trust agreement, the trust agreement will be regarded as having not yet come into force. If the crediting succeeds, the management module 145 will determine whether the settlor 2 passes the KYC check. If the KYC check does not pass, the management module 145 will send a trust creation failure notification to the settlor 2 through the settlor tracking module 113 and instruct, through the settlor module 11, the settlor 2 to provide client background information anew. If the settlor 2 passes the KYC check (S5), the management module 145 will send the trust agreement that passes the KYC check to the trustee 3 through the trustee integration module 122 in order for the trustee 3 to evaluate the trust agreement (S6). It is only when the trustee 3 agrees to take on the trust agreement and signs the trust agreement that the trust is created. The creation of the trust is regarded as “having not yet occurred” when the trustee 3 has not yet agreed to take on the trust agreement.

Referring to FIG. 3 and FIG. 4, after the trustee control interface 121 has received the trust agreement signed by the trustee 3, the signed trust agreement is sent from the trustee integration module 122 to the management module 145 of the trust digital management module 14 for storage and recordation therein (S7). The transaction module 143, through an authorization mechanism, including but not limited to the Electronic Direct Debit Authorization (eDDA for short), debits a bank accredited by a financial authority and designated by the settlor 2, or is directly series-connected to a bank app interface for debiting, and remits the amount to the bank account of the trustee 3 (S8). After the trustee integration module 122 has received the debited amount confirmation from the trustee 3, the management module 145 notifies the trustee 3 of the completion of creation of the trust through the trustee tracking module 123 and notifies the settlor 2 of the completion of creation of the trust through the settlor tracking module 113 (S9). The management module 145 and the execution module 146 of the trust digital management module 14 perform regular management on the trust and subsequently handle trust-related matters (S10).

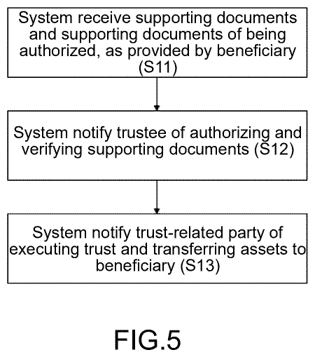

Referring to FIG. 5, there is shown a schematic view of a process flow of the trust digital management module 14 of the trust management system 1 of the disclosure. Upon the completion of creation of a trust, the management module 145 of the trust digital management module 14 performs regular management, for example, on trust execution conditions, by regularly inquiring a required interface or a database platform about whether the execution conditions are met (S11). In an embodiment of the disclosure, the database platform provides or publicizes personalized data kept by government agencies and allows people to download diverse data, receive online services, and combine related personalized data of the disclosure. The execution conditions are conditions for executing the trust, and an embodiment is herein provided for reference.

In a specific embodiment, settlor C creates a trust, and a clause thereof stipulates that a predetermined amount of US dollars shall be remitted to the trust account every month, with another clause stipulating that as soon as the daughter of settlor C turns 20 years old the trust shall stop account debiting and every year 8% of the trustee fund shall be withdrawn from the bank account of settlor C and remitted to a bank account designated by the beneficiary 4 (daughter). Upon the completion of creation of the trust agreement, the trust management system notifies the beneficiary 4 (daughter) of her obligation to authorize an inquiry performed by the trust management system on the database platform before the 15^{th} day of each month to access the household registry of the beneficiary 4 (daughter) until the beneficiary 4 (daughter) turns 20. Before confirming that the beneficiary 4 has turned 20, the trust management system automatically debits the bank account of settlor C. After confirming that the beneficiary 4 (daughter) has turned 20, the trust management system notifies the trustee 3 of its obligation to verify trust conditions. If the trustee 3 verifies that the trust conditions are met, the trustee 3 will execute the trust contents and notify all the trust-related parties of this.

The execution module 146 of the trust digital management module 14 executes the trust on a deadline according to agreed conditions set forth in the trust agreement. Alternatively, when the trust conditions are met, the execution module 146 of the trust digital management module 14 not only notifies the beneficiary 4 of its obligation to log in the beneficiary module 13 to provide trust conditions supporting documents or retrieval authorization supporting documents but also notifies the trustee 3 for verifying the supporting documents (S12). When the verification succeeds, the execution module 146 notifies the settlor 2 of the upcoming execution of the trust through the settlor tracking module 113, notifies the trustee 3 of the upcoming execution of the trust through the trustee tracking module 123, notifies the beneficiary 4 of the upcoming execution of the trust through the beneficiary tracking module 133, and transfers the trust assets to the beneficiary 4 (S13). If the verification fails, the trust management system 1 performs verification of conditions anew regularly.

All technical features of the aforesaid embodiments can be combined arbitrarily. For the sake of concise description, none of the possible combinations of the technical features of the aforesaid embodiments are described. However, the combinations of the technical features must be regarded as falling within the scope of the disclosure as long as they do not contradict each other.

The aforesaid embodiments merely illustrate several ways of implementing the disclosure and are described specifically and in detail but should not be interpreted to limit the claims of the disclosure. Persons skilled in the art can make some variations of and improvements on the aforesaid embodiments without departing from the spirit and scope of the disclosure, but the variations and improvements shall be deemed falling within the scope of the claims of the disclosure. Therefore, the legal protection for the disclosure shall be defined by the appended claims.

Unless otherwise specified, definitions for all technical and scientific terms used herein are the same as the meanings usually understood by persons skilled in the art. The technical terms explained herein are merely aimed at describing objectives of specific embodiments instead of limiting the disclosure. The expression “and/or” used herein indicates any combinations and all combinations of one or more related specified items.

Aspects of the disclosure are described herein and illustrated by a flowchart and/or a block diagram of a method, equipment (system), and computer program product in a specific embodiment of the disclosure. Each block in any flowchart and/or block diagram and a combination of blocks in any flowchart and/or block diagram can be implemented by computer program instructions. The computer program instructions are provided to a general-purpose computer, a special-purpose computer or a processor of any other programmable data processing apparatus to produce a machine of instructions, for example, and they are executed by devices of actions/functions specified in a flowchart and/or block diagram, through a computer or a processor of any other programmable data processing apparatus.

The computer program instructions are also stored in a computer-readable medium to instruct computers, other programmable data processing apparatuses and other devices to operate in a specific way. Thus, instructions stored inside the computer-readable medium generate a manufacturing subject, including implementing devices of actions/functions specified in a flowchart and/or block diagram.

What is claimed is:

1. A trust management system, comprising:
a settlor module comprising a settlor control interface and a settlor tracking module, the settlor control interface receiving a trust application filed by a client; and
a trust digital management module comprising a trust-related question bank,
wherein the settlor control interface presents a plurality of questions of the trust-related question bank, and the settlor module provides answers to the questions by the client to the trust digital management module so as to allow the trust digital management module to create a digital trust agreement according to the answers,
wherein the settlor control interface presents the digital trust agreement, the settlor module performs electronic signature function, and then notify the trust digital management module to conduct trust financial business online,
wherein the settlor tracking module issues a message notification to the client according to application progress.

2. The trust management system of claim 1, wherein the message notification is about a result of the trust financial business or about completion of creation of a trust.

3. The trust management system of claim 1, wherein the trust financial business comprises one of a crediting, an undoing crediting, a debiting, a remittance and an assets transfer.

4. The trust management system of claim 1, wherein the settlor module further comprises a settlor integration module connected to the trust digital management module and adapted to provide electronic signature function, and the settlor integration module presents a plurality of questions and the digital trust agreement through the settlor control interface.

5. The trust management system of claim 1, further comprising a trustee module comprising a trustee control interface and a trustee tracking module, wherein the trustee control interface presenting the digital trust agreement to a trustee, the trustee module executing the electronic signature function and then confirming that trust assets have been remitted to a trust account of the trustee to issue a trust creation notification to the settlor and the trustee.

6. The trust management system of claim 1, further comprising a beneficiary module comprising a beneficiary control interface and a beneficiary tracking module, wherein the beneficiary control interface presenting the digital trust agreement to a beneficiary, the beneficiary module receiving one or more supporting documents provided by the beneficiary or authorizing one or more supporting documents retrieved, and the beneficiary tracking module connecting to the trust digital management module to perform regular management tracking and notify the beneficiary.

7. The trust management system of claim 6, wherein, when trust agreement conditions are met, the trust digital management module notifies the trustee of its obligation to verify on the trustee control interface the supporting document(s) provided by the beneficiary or authorize the supporting document(s) retrieved and notify trust-related parties of executing the digital trust agreement and transferring trust assets to the beneficiary.

8. The trust management system of claim 6, wherein the trust digital management system further comprises a management module and an execution module, wherein the management module managing the trust conditions, managing the regular management and sending the message notification to the settlor module and the trustee module, wherein, when the trust conditions are met, the execution module executes the digital trust agreement and transfers trust assets to the beneficiary.

9. The trust management system of claim 1, wherein the trust digital management system further comprises a trust creation module, an analysis module, a transaction module and a digital information module, wherein the trust creation module linked to the analysis module and the digital information module to create the digital trust agreement, with the analysis module analyzing client background and needs, selecting the plurality of questions from the trust-related question bank of the digital information module according to the answers, and sending the plurality of questions to the trust creation module, the transaction module to be series-connected to a bank app interface to conduct the trust financial business.

10. A trust management method, comprising the steps of:
presenting at least one trust question and a digital trust agreement to a settlor through a settlor control interface to obtain a settlor electronic signature affixed by the settlor to the digital trust agreement;
executing online crediting and debiting of a designated account of the digital trust agreement;
confirming successful execution of the trust financial business and then presenting the digital trust agreement to a trustee through a trustee control interface to obtain a trustee electronic signature affixed by the trustee to the digital trust agreement;
debiting the designated account and remitting money to an account of the trustee;
notifying, upon confirmation of successful debiting, the client of creation of the digital trust agreement; and
executing regular management of the digital trust agreement.

11. The trust management method of claim 10, wherein the trust management system further performs the step of notifying, by a trust digital management module, regularly or according to the trust agreement, a beneficiary of its obligation to provide one or more supporting documents or authorize one or more retrieved supporting documents about trust conditions having been met.

12. The trust management method of claim 10, wherein the trust management system further performs the steps of:
inquiring, through a trust digital management module and a beneficiary tracking module, regularly about whether trust conditions are met;
verifying one or more supporting documents by the trustee on the trustee control interface when the trust conditions are met; and
executing the digital trust agreement and transferring trust assets to a beneficiary upon online verification of the supporting document(s).

13. The trust management method of claim 10, wherein the trust management system further performs the step of: issuing by the settlor control interface a failure information notification to the settlor if crediting and debiting fail.

14. The trust management method of claim 10, wherein the trust management system further performs the step of: issuing by the settlor control interface a failure information notification to the settlor if the trustee does not provide the trustee electronic signature affixed to the digital trust agreement.

15. The trust management method of claim 10, wherein, when the digital trust agreement stipulates that trust execution requires the settlor's consent or authorization of the trust execution, the settlor has to provide consent to or authorize the trust execution through the settlor control interface, wherein a trust digital management module transfers trust assets only after the trustee has received the consent or authorization from the settlor.
